(19) United States
(12) Patent Application Publication
(10) Pub. No.: US 2025/0254334 A1
(43) Pub. Date: Aug. 7, 2025

(54) INTRA MODE CODING BASED ON TEMPLATE

(71) Applicant: Tencent America LLC, Palo Alto, CA (US)

(72) Inventors: Biao WANG, Palo Alto, CA (US); Roman CHERNYAK, Palo Alto, CA (US); Lien-Fei CHEN, Palo Alta, CA (US); Yonguk YOON, Palo Alto, CA (US); Motong XU, Palo Alto, CA (US); Shan LIU, Palo Alto, CA (US); Ziyue XIANG, Palo Alto, CA (US)

(21) Appl. No.: 19/045,257

(22) Filed: Feb. 4, 2025

Related U.S. Application Data
(60) Provisional application No. 63/551,039, filed on Feb. 7, 2024.

(51) Int. Cl. H04N 19/159; H04N 19/105; H04N 19/176; H04N 19/196

(52) U.S. Cl. CPC H04N 19/159; H04N 19/105; H04N 19/176; H04N 19/196

(57) ABSTRACT

The various implementations described herein include methods and systems for coding video. An example method of video decoding includes receiving a video bitstream comprising a plurality of blocks that includes a current block. The method also includes, for each neighboring block in a set of neighboring blocks of the current block, when the neighboring block is coded using a template-based intra prediction mode derivation (TIMD), populating a candidate list for the current block with an entry for the neighboring block, where at least one entry in the candidate list comprises a three-mode entry. The method further includes reconstructing the current block using an entry from the candidate list.

### RELATED APPLICATIONS

This application claims priority to U.S. Provisional Patent Application No. 63/551,039, entitled “Improvement on Intra Mode Coding based on Template” filed Feb. 7, 2024, which is hereby incorporated by reference in its entirety.

### TECHNICAL FIELD

The disclosed embodiments relate generally to video coding, including but not limited to systems and methods for intra prediction mode coding.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates. ECM version 13 was published on Jul. 7, 2024 in MPEG 146.

### SUMMARY

The present disclosure describes amongst other things, a set of methods for video (image) compression, more specifically related to generating/populating an intra mode candidate list for a current block. For example, predefined neighboring positions of a current block (e.g., adjacent and/or non-adjacent neighboring blocks) may scanned for blocks using intra prediction modes (e.g., corresponding to template-based intra prediction mode derivation (TIMD) or TIMD-merge mode). The intra prediction modes of the neighboring blocks can be used to construct a candidate list for the current block. Each entry of the list may be a pair of primary and secondary intra modes as well as the associated weights for fusion. Each entry may also include a third (non-angular) mode, such as a DC mode, a planar mode, or an intra block copy (IBC) mode. A list index may be signaled in the video bitstream to indicate which entry is used for the current block. Generating a candidate list in this manner (with 2 mode entries and/or 3 mode entries) can improve coding accuracy, e.g., by allowing for a more accurate prediction mode to be identified and selected for use with the current block. Including the non-angular third mode in the entry can improve the coding accuracy (e.g., particularly for blocks having smooth texture/content).

In accordance with some embodiments, a method of video decoding is provided. The method includes (i) receiving a video bitstream (e.g., a coded video sequence) comprising a plurality of blocks (e.g., corresponding to a set of pictures) that includes a current block; (ii) for each neighboring block in a set of neighboring blocks of the current block, when the neighboring block is coded using TIMD, populating a candidate list for the current block with an entry for the neighboring block, where at least one entry in the candidate list comprises a three-mode entry; and (iii) reconstructing the current block using an entry from the candidate list.

In accordance with some embodiments, a method of video encoding includes (i) receiving video data (e.g., a source video sequence) comprising a current picture that includes plurality of blocks, the plurality of blocks including a current block; (ii) for each neighboring block in a set of neighboring blocks of the current block, when the neighboring block is coded using TIMD, populating a candidate list for the current block with an entry for the neighboring block, where at least one entry in the candidate list comprises a three-mode entry; (iii) encoding the current block using an entry from the candidate list; and (iv) signaling the encoded current block in a video bitstream.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates example directional intra prediction modes in accordance with some embodiments.

FIG. 4B illustrates example sample regions for matrix multiplication predictions in accordance with some embodiments.

FIG. 4C illustrates example template and references for a template-based intra prediction in accordance with some embodiments.

FIG. 4D illustrates an example of using reconstructed samples in a template to derive an intra prediction mode in accordance with some embodiments.

FIG. 4E illustrates an example intra block copy technique in accordance with some embodiments.

FIG. 4F illustrates an example of generating a merge candidate list in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques including constructing intra mode candidate lists. For example, for each neighboring block in a set of neighboring blocks of a current block, when the neighboring block is coded using TIMD, a candidate list may be populated for the current block with an entry for the neighboring block. At least one entry in the candidate list may be a three-mode entry that includes a non-angular mode. The current block can then be reconstructed using an entry from the candidate list. Populating a candidate list with three-mode entries corresponding to neighboring blocks can improve coding accuracy (e.g., by applying a more accurate intra prediction mode).

### Example Systems and Devices

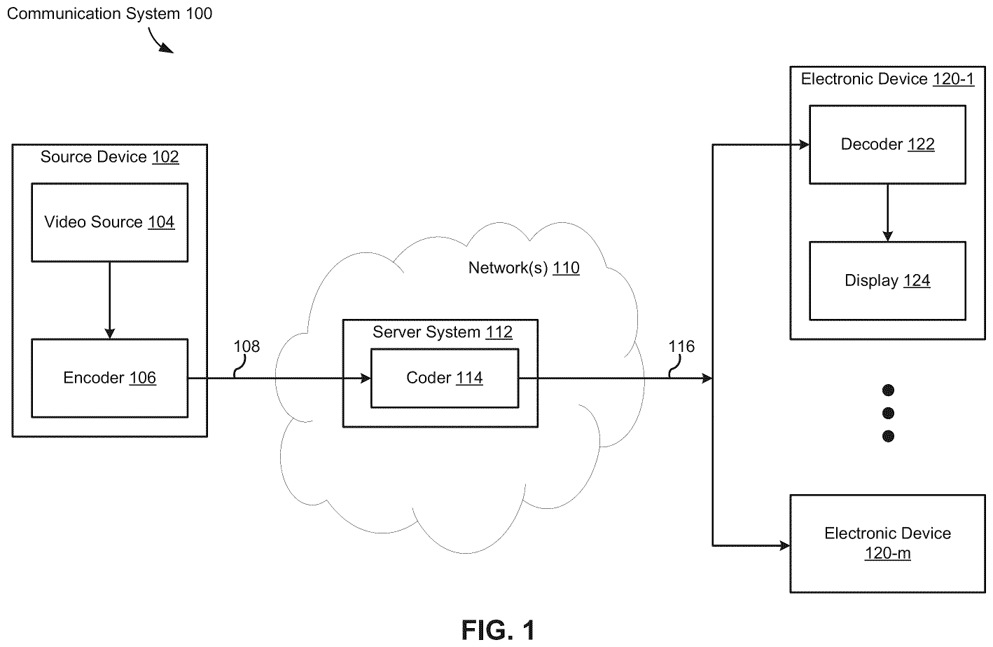

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

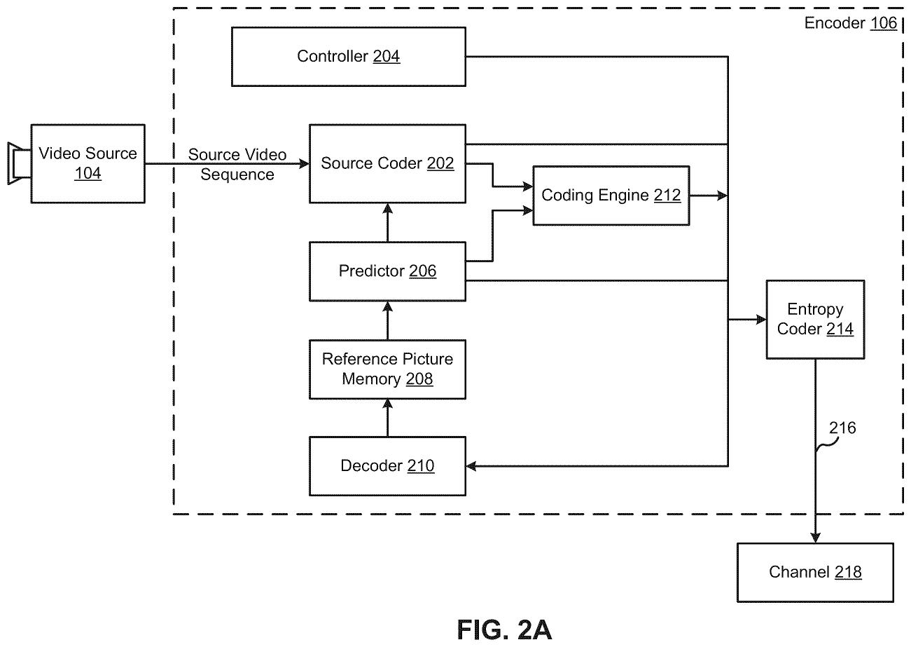

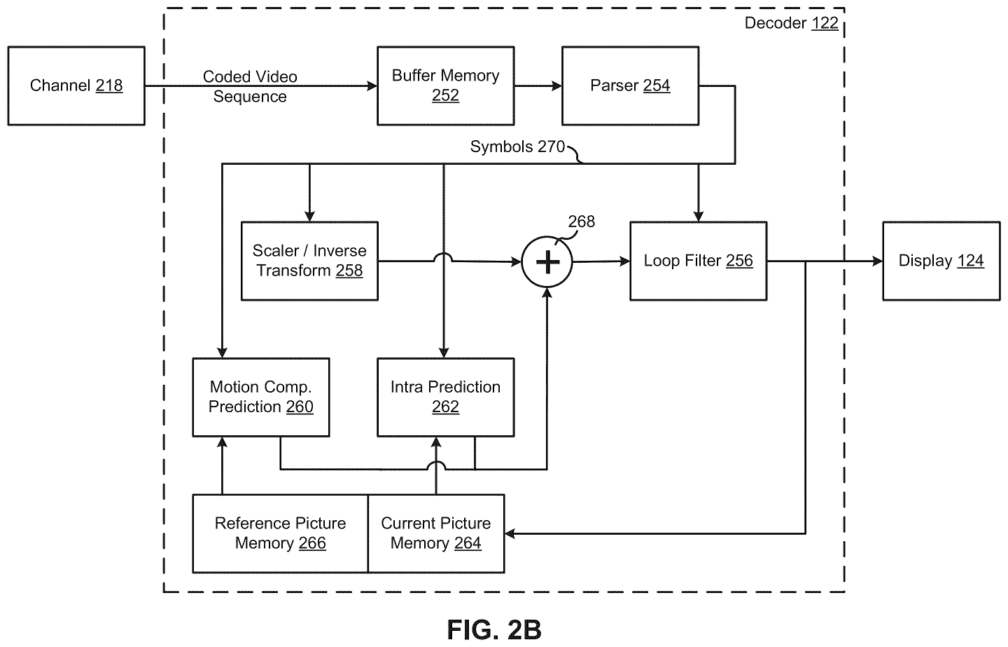

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum MV search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture MVs, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one MV and reference index to predict the sample values of each block. A Bi-directionally Predictive Picture may be coded and decoded using intra prediction or inter prediction using at most two MVs and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a MV. The MV points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, MVs, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by MVs. The MVs may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact MVs are in use, MV prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

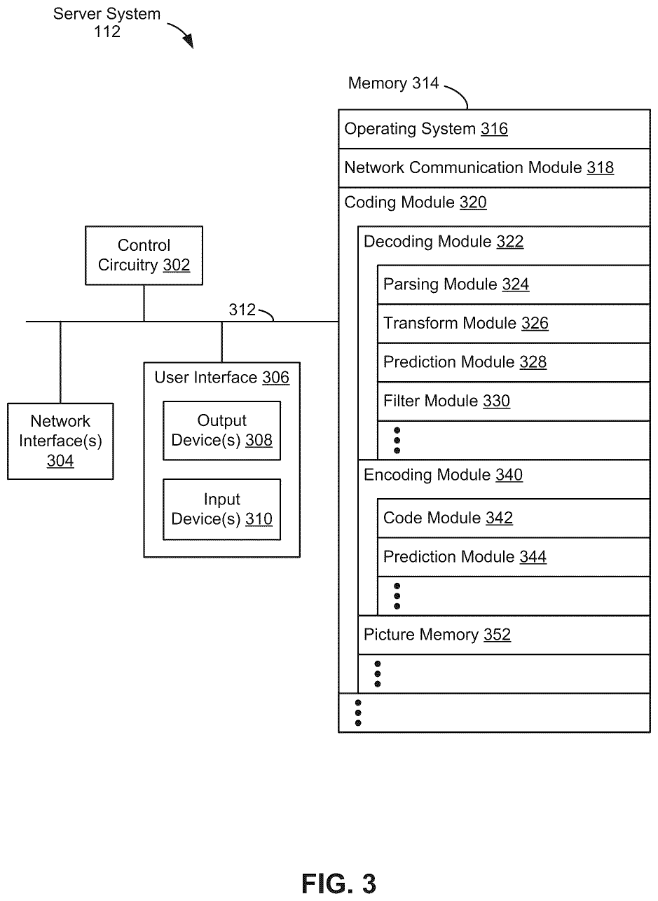

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, example methods for using template matching techniques to populate lists (used to reconstruct current blocks) are described below.

As is known to those of skill in the art, an intra block copy technique is a technique that identifies a prediction block for the current block using a block vector (BV). The BV is used to identify another block in the same picture of the current block that may be adjacent or non-adjacent to the current block. The BV may be either explicitly signaled or implicitly derived. When the BV is explicitly signaled, it is usually referred as an intra block copy (IBC) method. When the BV is implicitly derived, such as by comparing a template area (a group of neighboring reconstruction samples located adjacent to the block) between the current block and a candidate prediction block, it is usually referred as an intra template matching method or a TIMD method.

In some instances, a current coding block and its neighboring samples share similar texture characteristic. In such scenarios, the neighboring reconstructed samples of a current block, collectively called “a template,” can be employed to predict the current block. Template-matching may be used in inter prediction to derive the prediction block by calculating a distortion between the template of the current block and the template of the prediction block in the reference picture. Template-matching can also be applied in intra prediction, termed “intra template-matching,” on the reconstructed area of the current picture.

A “superblock size” or “coding tree unit (CTU)” may refer to the largest coding block size applied for coding an image/video picture or a video sequence. Additionally, block size (or region size) may refer to the block/region width, height, area size, number of samples in the block/region, a max (or min) between block/region width and height, and/or block/region aspect ratio.

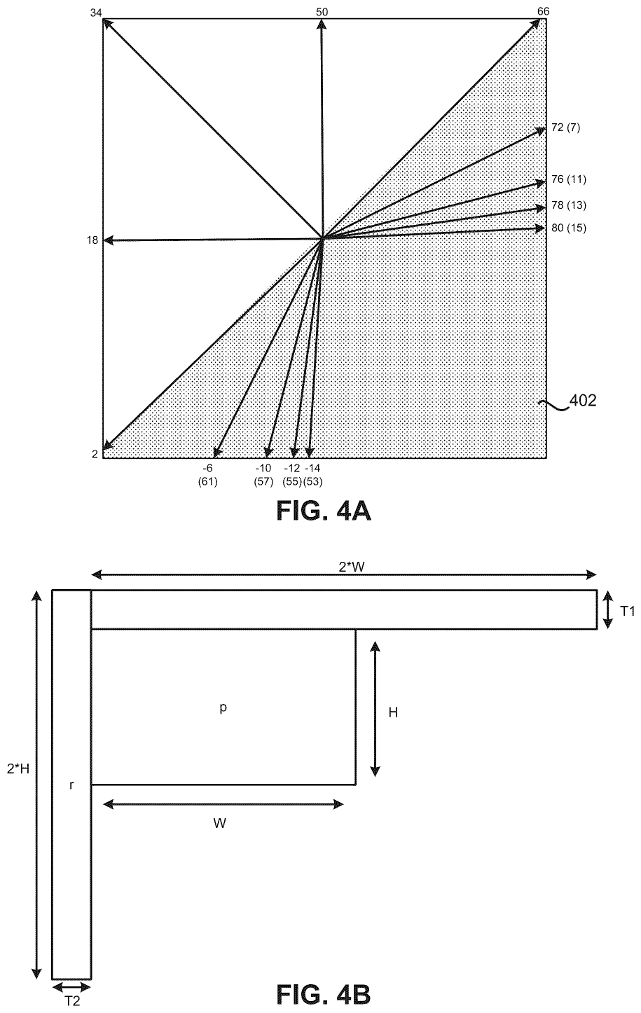

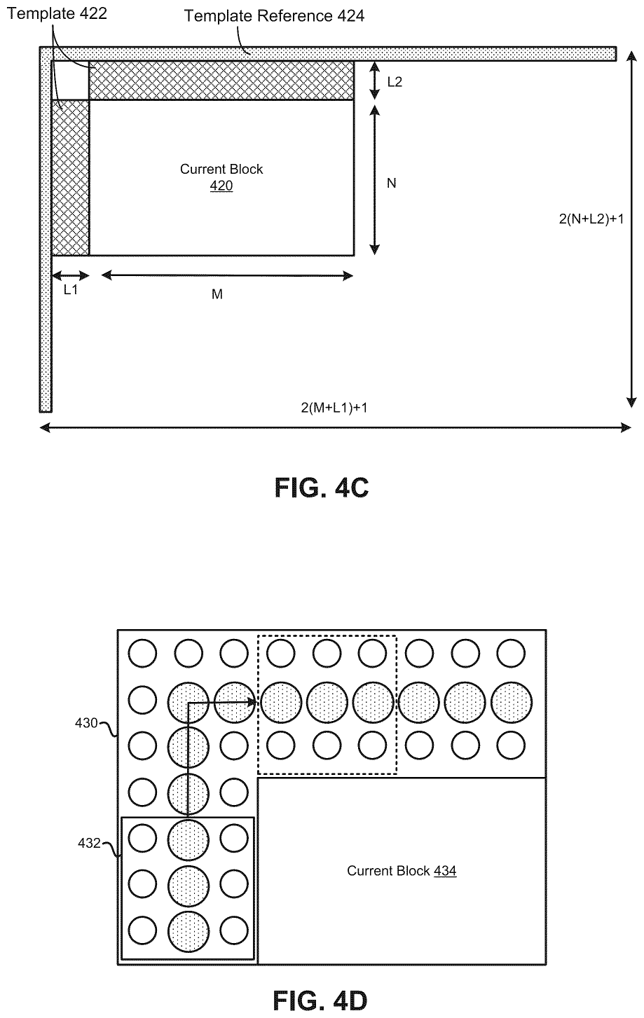

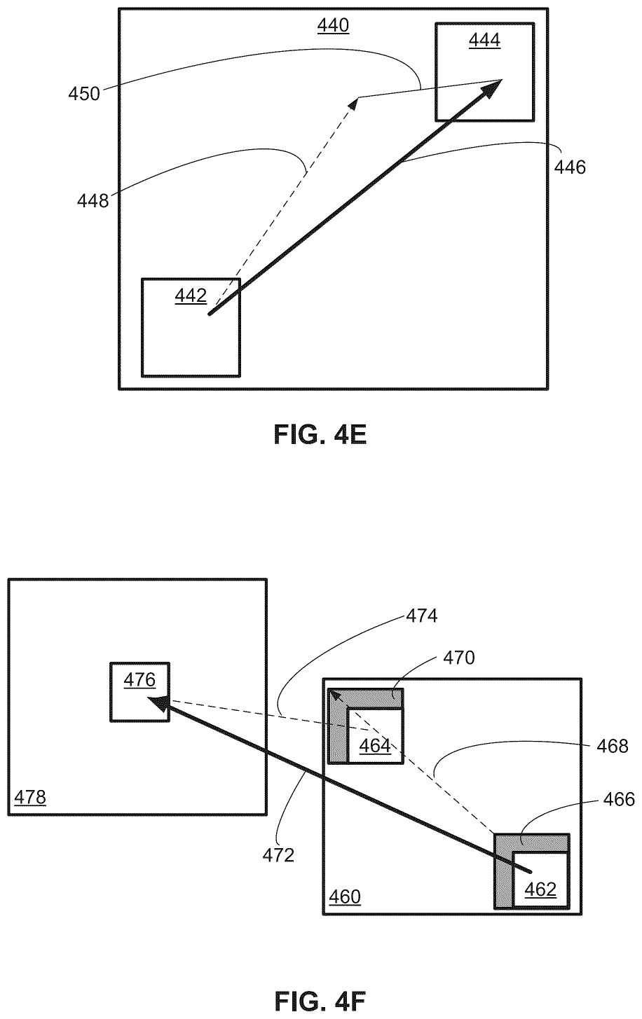

Intra prediction explores spatial redundancy between a current block and its neighboring samples. Conventionally, intra prediction modes can be classified as directional (angular) and non-directional modes (non-angular), indicating their directional or non-directional correlation between neighboring reference blocks and current block. FIG. 4A illustrates example directional intra prediction modes in accordance with some embodiments. The modes shown in FIG. 4A correspond to integer slope modes and additional fractional-slope mode may be interspersed between the integer-slope modes. The shaded area 402 in FIG. 4A corresponds to wide angles and the numbers in parentheses correspond to mapped modes for the wide-angle modes.

In a first example method, the intra prediction mode is explicitly signaled and its corresponding prediction signal is generated using interpolation filter applied on reference samples.

In a second example method, an intra prediction signal is generated using reference samples multiplied with weighted coefficients. These weighted coefficients may be trained offline and stored as a matrix. FIG. 4B illustrates example sample regions for matrix multiplication predictions in accordance with some embodiments. In FIG. 4B, W and H represents the width and the height of the current prediction block, p. Reference samples on the top and left with double size width and double size height are considered. The number of sample lines on the top and left are denoted as T1 and T2. In this example, the prediction signal is given by Equation 1 below.

$$\begin{matrix}Matrix Multiplication Prediction & \\ P ( x , y ) = {\sum }_{k} F ( x , y , k ) * r ( k ) & Equation 1\end{matrix}$$

Where F(x, y, k) is the trained coefficients and r(k) is the considered reference samples. In Equation 1, (x, y) represents the coordinates within the current prediction block, and k is the iterator going through all reference samples. The final predictor is a weighted sum of all reference samples.

FIG. 4C illustrates example template and references for a template-based intra prediction in accordance with some embodiments. In some embodiments, a template shape is selected for a current block. In FIG. 4C, a current block (e.g., a coding unit (CU)) 420 is shown with a corresponding template 422. In the example of FIG. 4C, the current block 420 has a height of N and a width of M. The template 422 in FIG. 4C has a width of L1 along a left region (e.g., having a height of N), and a height of L2 along a top region (e.g., having a width of M). In some embodiments, the template 422 has a different shape and/or different dimensions. For example, in some embodiments, the template 422 includes sample(s) to the top-left of the current block 420. In accordance with some embodiments, a template reference 424 is defined for the template 422. The template reference 424 corresponds to a group of samples used to generate a prediction signal for the template 422. In the example of FIG. 4C, the template reference 424 has a height of 1 sample along a top region and a width of 1 sample along a left region.

FIG. 4D illustrates an example of using reconstructed samples in a template to derive an intra prediction mode in accordance with some embodiments. In FIG. 4D, a template region 430 is shown for a current block 434. In the example of FIG. 4D, a 3×3 window 432 is used to assess sets of reference samples. The window 432 may be slid within the template region to obtain different candidates. As shown in FIG. 4C, samples located in the top and left of the current coding block may be used as the template. Specifically, three sample rows and columns are included in the template and the texture direction of neighboring samples can be estimated by the following steps. First, a horizonal and vertical Sobel 3×3 filter can be applied on a 3×3 window, with the highlight middle row and column samples as the center, to get a horizonal gradient Gx and vertical gradient Gy. Next, the ratio of Gx and Gy can be calculated for each 3×3 window within the template (e.g., the intra mode information of neighboring template). Then, the ratio of Gx and Gy can be matched to the conventional closest intra prediction mode and count store matched intra mode in a histogram. Next, the 3×3 window can be slid across the template and the histogram updated according to the matched intra mode per each 3×3 window. Finally, one or more top frequently matched intra modes associated with the derived texture direction in the histogram can be used as the intra prediction mode. For example, a set of top five histograms are collected and five top corresponding intra modes are obtained, noted as M0, M1, M2, M3, and M4 (e.g., with M0 has the highest histogram and M4 the lowest). The final predictor might be a fusion of a non-directional predictor (such as planar mode predictor) and the five predictors respectively predicted by M0 to M4.

FIG. 4E illustrates an example of an intra block copy technique in accordance with some embodiments. In this example, the intra block copy technique includes identifying, via a predicted BV 448, a prediction block 444 within the same picture 440 as a current block 442. FIG. 4E shows an example in which the prediction block 444 is non-adjacent to the current block 442. In some embodiments, the prediction block 444 may is adjacent to the current block 442. In some embodiments, the prediction BV 448 is selected from a list of candidate BVs. For example, the list of candidate BVs may be populated by BVs used in neighboring blocks and/or BVs from a BV bank. A BV predictor index may be signaled to indicate which candidate BV in the candidate list is used to predict the BV for the current block 442.

In some embodiments, a BV difference (BVD) 450 represents the difference between the predicted BV and an actual BV 446, which is the vector between corresponding portions of the current block (e.g., current block 442) and the prediction block (e.g., prediction block 444). While the BVD 450 depicted in FIG. 4EA has components along both the horizontal and vertical dimensions, a BVD may extend along a single dimension or span two or more dimensions. In some embodiments, the BVD 450 includes information representing a magnitude of a BV difference and/or a direction of the BV difference, one or both of which may be signaled in the bitstream as intra block copy information or syntaxes.

As described above, neighboring reconstructed samples of a current block, collectively called “a template,” may be used to predict the current block. In some embodiments, a template-matching process is applied to a current picture to find at least one adjacent and/or non-adjacent block having motion vector (MV) and/or BV information to usable for the current block. The MV and/or BV from that adjacent block and/or non-adjacent block is used to construct a merge candidate list for the current block. FIG. 4F illustrates an example of generating a merge candidate list in accordance with some embodiments. In FIG. 4F, a current picture 460 includes a current block 462. A template matching process (e.g., intra-template matching) is used to identify a BV 468 (e.g., also denoted as BV) of the current block 462, in accordance with some embodiments. The current block 462 has a template 466 that includes a number of reconstructed samples. A distortion between the template 466 and other templates within the current picture 460 (e.g., templates formed by reconstructed samples in the current picture 460) is calculated, and a prediction block 464 is identified, which is associated with a template 470 having a small or smallest distortion, and/or the lowest template-matching cost (e.g., based on sum of absolute difference (SAD), SATD, sum of squared error (SSE), or another metric), thereby identifying the BV 468. In the example of FIG. 4F, the predicted block 464 has a MV 474, also denoted as MV_{A′}, that points to a reference block 476 in a reference picture 478. A merge candidate 472 (e.g., also denoted as MV) is derivable by either adding the BV 468 and the MV 474 (e.g., MV=MV_{A′}+BV), or setting the merge candidate 472 as equal the MV 474 (e.g., MV=MV_{A′}). For example, when the merge candidate 472 is set as the MV 474, the merge candidate 472 does not account for the non-adjacency of the prediction block 464 to the current block 462 (e.g., the displacement, via BV, of the prediction block 414 from the current block 462, is ignored).

In some embodiments, the merge candidate 472 (e.g., MV_{A′}) is derived from a predefined motion field within prediction block 464 having dimensions W×H. For example, the prediction block 464 (e.g., 32×32, same size as current block 462) may include multiple subblocks (e.g., each subblock having a size of 4×4, resulting in an arrangement of 8×8 different subblocks, containing 64 MV information data).

In some embodiments, the prediction block is searched within a smaller predefined search area within a reconstruction area of the current picture 460. For example, a search range restriction can be applied to search within a search range of a fixed size, to search within a current CTU row, to search within the current CTU row and/or to search within the N previously coded CTU row(s), etc. In some embodiments, instead of finding a single prediction block 464, additional prediction blocks (e.g., N different prediction blocks) having the lowest N template matching costs are identified and used for list construction.

In some embodiments, instead of the L-shaped templates (e.g., template 466 and the template 470) shown in FIG. 4F, a template of a different shape is used for intra template-matching. For example, only a left template (e.g., left portion of the L-shaped template 466), or only a top template (e.g., the horizontal portion of the L-shaped template 466), or a top-left template (e.g., the L-shaped template 466) is used. For example, for smaller blocks (e.g. blocks smaller than or equal a size threshold, such as 64, 32, or a different value), a template having two lines of reconstructed samples is used while for blocks larger than the size threshold (e.g., larger than 64, 32, or a different value), a template having four lines of reconstructed samples is used. Thus, the template size may be block-size dependent. In some embodiments, the templates having different template-matching types and shapes are adaptively selected at the block level (e.g., using any kind of optimization method to determine which template type is the best at the time of coding the current block) and a syntax is signaled into the bitstream by the encoder to indicate which template type and/or shape is used.

In some embodiments, pixel subsampling within the template is used in the template-matching process to calculate the template-matching cost. For example, for a template of 16×2 size, instead of calculating a pixel difference (e.g., an absolute difference) for each of the 32 pixels (e.g., all samples within the template), pixel differences are only calculated partially, for example, for just the even positions. Pixel subsampling allows a reduction in computation time and may help with hardware designs. In some embodiments, the template matching process is performed at a coarser step. For example, the step of search is changed to two samples per iteration instead of searching every sample (e.g., step size of one). For example, instead of searching every position in a 32×32 block, search is conducted at only even or only odd positions, so that the search is only conducted in a partial region.

In some embodiments, the candidates identified from template-matching are inserted into the candidate list before candidates derived/selected from other means. For example, candidates obtained through intra-template matching may be more similar to the current block than other candidates.

In a third example method, a template-based intra prediction mode derivation is applied on a current coding block. When the template and current coding block are well correlated, the intra prediction mode applied for the template gives a good indication for the current block. An example, intra mode derivation using a template is summarized in the following steps. In a first step a group of samples are defined as reference of the template (e.g., the template reference 424). These samples are used as reference samples to generate prediction signal of the template. In a second step, an intra prediction mode is exercised to generate the prediction of the template. In a third step, a cost (e.g., sum of absolute transform differences (SATD) cost) is calculated between the prediction signal and reconstruction signal of the template. In a fourth step, the second and third steps are repeated for modes in a predefined intra prediction mode set and the predefined intra modes are stored based on their respective costs. In a fifth step, the mode with the least cost is chosen as the prediction mode for the current block, and the mode with the second least cost is chosen as the secondary prediction mode for the current block. For the convenience of description, these two modes may be referred to as the primary and secondary template-based intra modes. In a sixth step, a final predictor is selected as either a fusion of the two predictors or the predictor from the primary mode (e.g., based on the cost difference between the primary and secondary template-based intra modes).

For example, consider two modes (Mode1 and Mode2) with associated costs (costMode1 and costMode2). As an example, the costs of the two selected modes are compared with a threshold where the cost factor of 2 is applied (e.g., costMode2 is less than 2×the costMode1). If this condition is true, the fusion is applied, otherwise the only Mode1 is used. The weights of the modes may be computed from their SATD costs, e.g., weight1=costMode2/(costMode1+costMode2) and weight2=1−weight1.

In a fourth example method, predefined neighboring positions of current block (in adjacent and/or non-adjacent neighboring blocks) are scanned for blocks, e.g., using the third example method. A candidate list may be constructed based on the prediction modes of the scanned neighboring blocks, where each entry of the list is a pair of primary and secondary intra modes as well as the used weight for fusion. A list index may be signaled in the bitstream to indicate which entry's information is inherited by the current block.

In a fifth example method, in addition to the primary and secondary template-based intra modes, a third mode is added for fusion. This third intra mode may be a non-angular mode (such as a planar mode, a DC mode, or an IBC mode). The cost of templates using these non-angular modes may be computed, and the non-angular mode with the least cost is used as the non-angular mode for fusion. The fusion weights may be computed based on the cost of the primary, secondary, and tertiary modes.

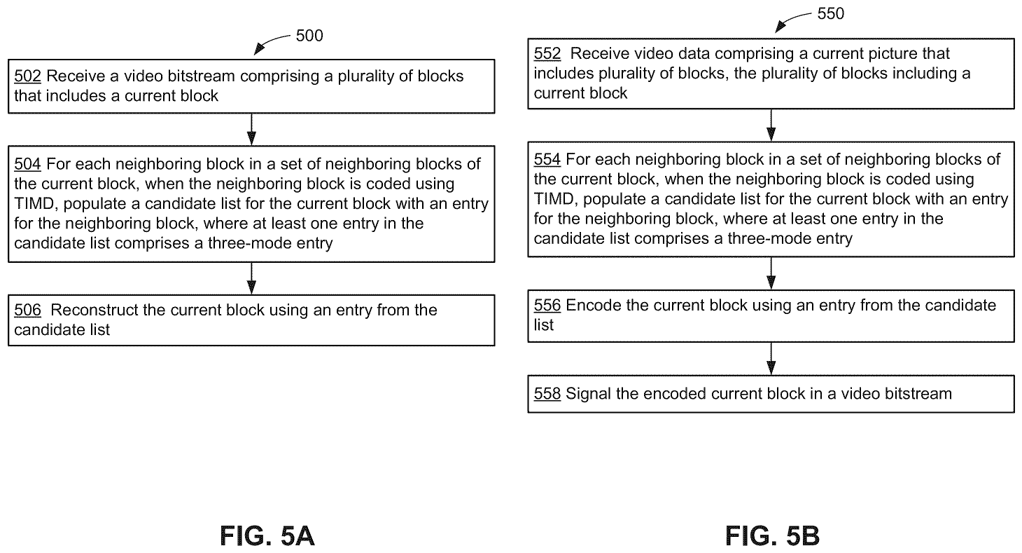

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) a video bitstream (e.g., a coded video sequence) comprising a plurality of blocks (e.g., corresponding to a set of pictures) that includes a current block. For each neighboring block in a set of neighboring blocks of the current block, when the neighboring block is coded using TIMD, the system populates (504) a candidate list for the current block with an entry for the neighboring block, where at least one entry in the candidate list comprises a three-mode entry. The system reconstructs (506) the current block using an entry from the candidate list. In this way, a candidate list may be adaptively generated with a third non-angular mode. For example, for an entry in the fourth example method may be ((Mₚ, Mₛ), (Wₚ, Wₛ)), and the three-mode entry in the candidate list is ((Mₚ, Mₛ, Mₙ), (Wₚ, Wₛ, Wₙ)), where Mₚ, Mₛ, Mₙ represents the primary, secondary, and third mode, and Wₚ, Wₛ, Wₙ represents the weights of primary, secondary, and third modes, respectively.

In some embodiments, a syntax is explicitly signaled to indicate whether a two-mode or three-mode entry is used to construct a candidate list. For example, all entries in the candidate list are in the form of ((Mₚ, Mₛ), (Wₚ, Wₛ)) or in the form of ((Mₚ, Mₛ, Mₙ), (Wₚ, Wₛ, Wₙ)).

In some embodiments, the candidate list is constructed in a heterogeneous way. In this case, an entry in the list either has a form of ((Mₚ, Mₛ), (Wₚ, Wₛ)) or ((Mₚ, Mₛ, Mₙ), (Wₚ, Wₛ, Wₙ)). The heterogeneous candidate list may be implicitly enabled or explicitly enabled by signaling a flag.

In some embodiments, both ((Mₚ, Mₛ), (Wₚ, Wₛ)) and ((Mₚ, Mₛ, Mₙ), (Wₚ, Wₛ, Wₙ)) from the adjacent and/or non-adjacent blocks are used to construct the candidate list.

In some embodiments, the template cost is used to sort the whole candidate list in ascending order.

In some embodiments, the template cost between ((Mₚ, Mₛ), (Wₚ, Wₛ)) and ((Mₚ, Mₛ, Mₙ), (Wₚ, Wₛ, Wₙ)) is determined and the parameter set of mode and weight which has smallest cost is selected to construct the candidate list.

In some embodiments, the candidate list is constructed in a grouped way, where the first group contains only two-mode entries whereas the second group contains only three-mode entries. For example, the two groups are sorted based on a SATD cost (or SAD cost or SSE cost), and only the first entry is selectable from the two groups.

In some embodiments, when computing a cost for each entry, the cost is a combined weight cost for a two-mode or three-mode entry. For example, for a two-mode entry, the cost may be calculated as shown below in Equation 1.

$$\begin{matrix}Two - Mode Cost & \\ Cost = ( S ATD ( {IPM}_{1} ) * {W}_{1} + S ATD ( {IPM}_{2} ) * {W}_{2} ) >> shift & Equation 1\end{matrix}$$

As another example, for a three-mode entry, the cost may be calculated as shown below in Equation 2.

$$\begin{matrix}Three - Mode Cost & \\ Cost = ( S ATD ( {IPM}_{1} ) * {W}_{1} + S ATD ( {IPM}_{2} ) * {W}_{2} + S ATD ( {IPM}_{3} ) * {W}_{3} ) >> shift & Equation 2\end{matrix}$$

In some embodiments, a syntax flag is signaled to indicate from which group the prediction information is inherit. In some embodiments, the selection of two group is implicitly determined by side codec information, such as prediction mode, block size, etc.

In some embodiments, the fourth example method is only enabled when there are at least N neighboring blocks using one of the third, fourth, or fifth example method, where N is a positive integer number.

In some embodiments, the length of the candidate list is adaptively determined. For example, the length is determined based on block size. In another example, the length is determined based on whether dual-tree or single tree coding strategy is used. In another example, the length is determined based on a threshold and the threshold is derived based on the least cost of the candidate list. For example, when entries' cost is larger than this threshold, they are excluded from the list.

In some embodiments, the cost is calculated based metrics such as SATD, SAD, mean removal SAD, etc.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data (e.g., a source video sequence) comprising a current picture that includes a plurality of blocks (e.g., corresponding to a set of pictures), including a current block. For each neighboring block in a set of neighboring blocks of the current block, when the neighboring block is coded using TIMD, the system populates (554) a candidate list for the current block with an entry for the neighboring block, where at least one entry in the candidate list comprises a three-mode entry. The system encodes (556) the current block using an entry from the candidate list. The system signals (558) the encoded current block in a video bitstream. As described previously, the encoding process may mirror the decoding processes described herein (e.g., using intra-template matching as described above). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

Block vector-based predictions are used for intra blocks as described previously. In addition to the regular block-vector based prediction modes of IBC and IntraTMP, the block vectors can be used in SGPM, TIMD, and DIMD modes to enhance the corresponding predictions. As described previously the block vector-based prediction may be used in combination with a directional prediction (e.g., used with DIMD). For example, the merge candidates (adjacent and/or non-adjacent) can be evaluated with the template costs to select the lowest cost block vector predictor to be combined with the directional modes. TIMD can also make use of block vector predictions (e.g., similar to SGPM and DIMD modes). Specifically, any of the fusion modes of TIMD can be replaced by a block vector-based prediction (e.g., from merge candidates) based on the template cost. As an example, when deriving the intra modes of TIMD (e.g., 2 angular and 1 non-angular), the block vectors of the merge candidates of IntraTMP mode may be checked. If the template cost is smaller than any of the other modes, the mode may be replaced by the block vector. Simulation data on ECM-12 software with common test conditions has shown that using more than two-entry modes improves the coding of the luma (Y) component by 0.11%, improves the coding of the chroma (U) component by 0.03%, and improves the coding of the chroma (V) component by 0.03%.
(A1) In one aspect, some embodiments include a method (e.g., the method 500) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks that includes a current block; (ii) for each neighboring block in a set of neighboring blocks of the current block, when the neighboring block is coded using TIMD, populating a candidate list for the current block with an entry for the neighboring block, where at least one entry in the candidate list comprises a three-mode entry; and (iii) reconstructing the current block using an entry from the candidate list. For example, a candidate list is constructed adaptively with a third non-angular mode. An example entry in the candidate list is ((Mₚ, Mₛ, Mₙ), (Wₚ, Wₛ, Wₙ)), where Mₚ, Mₛ, Mₙ represents the primary, secondary, and third modes, and Wₚ, Wₛ, Wₙ represents the weights of primary, secondary, and third modes, respectively. In some embodiments, each entry in the candidate list includes a primary mode with a corresponding first weight and a secondary mode with a corresponding second weight.
(A2) In some embodiments of A1, the three-mode entry includes a primary mode, a secondary mode, and a non-angular mode.
(A3) In some embodiments of A1 or A2, the method further includes parsing an indicator from the video bitstream, where the indicator indicates whether the candidate list comprises at least one three-mode entry. For example, a first value for the indicator may indicate that the candidate list is composed of only two-mode entries (e.g., primary and secondary modes), whereas a second value for the indicator may indicate that the candidate list is composed of at least one three-mode entry (e.g., primary, secondary, and non-angular modes). In some embodiments, the indicator indicates whether the candidate list is composed of only three-mode entries (e.g., every entry in the candidate list is a three-mode entry). As an example, a syntax is explicitly signaled to indicate whether two-mode or three-mode entries are used to construct a candidate list. In this way, all entries in the candidate list may be in the form of ((Mₚ, Mₛ), (Wₚ, Wₛ)) or in the form of ((Mₚ. Mₛ, Mₙ), (Wₚ, Wₛ, Wₙ)).
(A4) In some embodiments of any of A1-A3, the candidate list further comprises at least one two-mode entry. For example, the candidate list is constructed in a heterogeneous way in which an entry in the list either has a form of ((Mₚ, Mₛ), (Wₚ, Wₛ)) or ((Mₚ, Mₛ, Mₙ), (Wₚ, Wₛ, Wₙ)). The heterogeneous candidate list is either implicitly enabled or explicitly enabled by signaling a flag.
(A5) In some embodiments of any of A1-A4, the method further includes parsing an indicator from the video bitstream, where the indicator indicates whether the candidate list is a heterogenous candidate list. For example, the indicator indicates whether the candidate list includes both a two-mode entry and a three-mode entry. The heterogeneous candidate list is either implicitly enabled or explicitly enabled by signaling a flag.
(A6) In some embodiments of any of A1-A5, the set of neighboring blocks includes at least one adjacent neighboring block and at least one non-adjacent neighboring block.
(A7) In some embodiments of any of A1-A6, the method further includes, for a neighboring block in the set of neighboring blocks, inserting at two-mode entry and a three-mode entry into the candidate list. For example, both of ((Mₚ, Mₛ), (Wₚ, Wₛ)) and ((Mₚ, Mₛ, Mₙ), (Wₚ, Wₛ, Wₙ)) from a neighboring block are used to construct/populate the candidate list.
(A8) In some embodiments of any of A1-A7, the method further includes generating a sorted candidate list by sorting the candidate list according to a respective template cost associated with each entry, where the entry from the candidate list used to reconstruct the current block is the top entry in the sorted candidate list. For example, the template cost is used to sort the whole candidate list in ascending order.
(A9) In some embodiments of A8, the respective template cost associated with each entry comprises a combined weight cost for the entry. For example, when computing SATD cost for each entry, the cost is a combined weight cost for two-mode or three-mode entry. For example, for a two-mode entry the cost may be calculated as shown in Equation 2. As another example, for a three-mode entry the cost may be calculated as shown in Equation 3.
(A10) In some embodiments of any of A1-A9, the method further includes, for a neighboring block in the set of neighboring blocks: (i) determining a first template cost for a two-mode entry for the neighboring block; (ii) determining a second template cost for a three-mode entry for the neighboring block; (iii) when the first template cost is less than the second template cost, populating the candidate list with the two-mode entry; and (iv) when the second template cost is less than the first template cost, populating the candidate list with the three-mode entry. For example, the template cost between ((Mₚ, Mₛ), (Wₚ, Wₛ)) and ((Mₚ, Mₛ, Mₙ), (Wₚ, Wₛ, Wₙ)) is determined and the parameter set of mode and weight which has smallest cost is selected to construct the candidate list. In some embodiments, a first template cost is determined for a first two-mode entry having a first set of weights, a second template cost is determined for a second two-mode entry having a second set of weights, a third template cost is determined for a first three-mode entry having a third set of weights, and a fourth template cost is determined for a second three-mode entry having a fourth set of weights; and the template having the lowest cost is added to the candidate list.
(A11) In some embodiments of any of A1-A10, the candidate list is arranged so that a first group of adjacent entries consist of two-mode entries and a second group of adjacent entries consist of three-mode entries. For example, the candidate list is constructed in a grouped way in which the first group contains only two-mode entries and the second group contains only three-mode entries.
(A12) In some embodiments of A11, the method further includes: (i) sorting the first group according to costs associated with respective two-mode entries; (ii) sorting the second group according to costs associated with respective three-mode entries, wherein the second group is sorted independently from the first group. For example, the two groups are sorted based on the SATD cost. In some embodiments, only the first entry is able to be selected from each of the two groups. The costs described herein may refer to SATD-based costs, SAD-based costs, mean-removal SAD-based costs, and/or costs determined from other cost functions.
(A13) In some embodiments of A11 or A12, the method further includes parsing an indicator from the video bitstream, where the indicator indicates whether the entry is from the first group or the second group. For example, a syntax flag is signaled to indicate from which group the prediction information is inherited.
(A14) In some embodiments of A11 or A12, the method further includes determining whether to select the entry from the first group or the second group based on coded information. For example, the selection of two group is implicitly determined by coded information, such as prediction mode, block size, and the like.
(A15) In some embodiments of any of A1-A14, the method further includes determining whether at least a predetermined number of neighboring blocks are coded using TIMD, where the candidate list is constructed when at least the predetermined number of the neighboring blocks are coded using TIMD. For example, a candidate list-based mode is only enabled when there are at least N neighboring blocks using TIMD, where N is a positive integer number (e.g., 1, 2 or 3).
(A16) In some embodiments of any of A1-A15, the method further includes determining a size of the candidate list for the current block. For example, the length of the candidate list is adaptively determined.
(A17) In some embodiments of A16, the size of the candidate list is determined based on at least one of: (i) a block size of the current block; and (ii) whether a dual-tree or single-tree coding is used for the current block. For example, the length is determined based on block size. As another example, the length is determined based on whether dual-tree or single tree coding strategy is used.
(A18) In some embodiments of A16 or A17, the size of the candidate list is based on a number of entries corresponding to the set of neighboring blocks that have a cost that is less than a predetermined value. For example, the length is determined based on a threshold and the threshold is derived based on the least SATD cost of the candidate list. In this example, when an entry's cost is larger than the threshold, the entry is excluded from the list, otherwise the entry is included in the list (e.g., and the list grows to accommodate the additional entry).
(B1) In another aspect, some embodiments include a method (e.g., the method 550) of video encoding. In some embodiments, the method is performed at a computing system (e.g., the server system 112) having memory and control circuitry. In some embodiments, the method is performed at a coding module (e.g., the coding module 320). The method includes (i) receiving video data (e.g., a source video sequence) comprising a current picture that includes plurality of blocks, the plurality of blocks including a current block; (ii) for each neighboring block in a set of neighboring blocks of the current block, when the neighboring block is coded using TIMD, populating a candidate list for the current block with an entry for the neighboring block, where at least one entry in the candidate list comprises a three-mode entry; (iii) encoding the current block using an entry from the candidate list; and (iv) signaling the encoded current block in a video bitstream. In some embodiments, the video bitstream includes a set of indicators, including one or more of: an indicator indicating how to sort the candidate list, an indicator indicating whether the candidate list includes both two-mode and three-mode entries, and an indicator indicating whether to group two-mode and three-mode entries. Some embodiments of B1 include applying any of the techniques described above in A2-A18.
(C1) In another aspect, some embodiments include a method of visual media data processing. In some embodiments, the method is performed at a computing system (e.g., the server system 112) having memory and control circuitry. In some embodiments, the method is performed at a coding module (e.g., the coding module 320). The method includes: (i) obtaining a source video sequence that comprises a plurality of frames; and; (ii) performing a conversion between the source video sequence and a video bitstream of visual media data according to a format rule, the video bitstream comprises a current block corresponding to a current picture; and the format rule specifies that: (a) for each neighboring block in a set of neighboring blocks of the current block, when the neighboring block is coded using TIMD, a candidate list is to be populated for the current block with an entry for the neighboring block, where at least one entry in the candidate list comprises a three-mode entry; and (b) the current block is to be reconstructed using an entry from the candidate list.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A18, B1, and C1 above). In yet another aspect, some embodiments include a non-transitory computer-readable storage medium storing one or more sets of instructions for execution by control circuitry of a computing system, the one or more sets of instructions including instructions for performing any of the methods described herein (e.g., A1-A18, B1, and C1 above). In some embodiments, a non-transitory computer-readable storage medium stores a video bitstream that is generated by any of the video encoding methods described herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context. As used herein, N refers to a variable number. Unless explicitly stated, different instances of N may refer to the same number (e.g., the same integer value, such as the number 2) or different numbers.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks that includes a current block;
for each neighboring block in a set of neighboring blocks of the current block, when the neighboring block is coded using a template-based intra prediction mode derivation (TIMD), populating a candidate list for the current block with an entry for the neighboring block, wherein at least one entry in the candidate list comprises a three-mode entry; and
reconstructing the current block using an entry from the candidate list.

2. The method of claim 1, wherein the three-mode entry includes a primary mode, a secondary mode, and a non-angular mode.

3. The method of claim 1, further comprising parsing an indicator from the video bitstream, wherein the indicator indicates whether the candidate list comprises at least one three-mode entry.

4. The method of claim 1, wherein the candidate list further comprises at least one two-mode entry.

5. The method of claim 4, further comprising parsing an indicator from the video bitstream, wherein the indicator indicates whether the candidate list is a heterogenous candidate list.

6. The method of claim 1, wherein the set of neighboring blocks includes at least one adjacent neighboring block and at least one non-adjacent neighboring block.

7. The method of claim 1, further comprising, for a neighboring block in the set of neighboring blocks, inserting at two-mode entry and a three-mode entry into the candidate list.

8. The method of claim 1, further comprising generating a sorted candidate list by sorting the candidate list according to a respective template cost associated with each entry, wherein the entry from the candidate list used to reconstruct the current block is the top entry in the sorted candidate list.

9. The method of claim 8, wherein the respective template cost associated with each entry comprises a combined weight cost for the entry.

10. The method of claim 1, further comprising, for a neighboring block in the set of neighboring blocks:
determining a first template cost for a two-mode entry for the neighboring block;
determining a second template cost for a three-mode entry for the neighboring block;
when the first template cost is less than the second template cost, populating the candidate list with the two-mode entry; and
when the second template cost is less than the first template cost, populating the candidate list with the three-mode entry.

11. The method of claim 1, wherein the candidate list is arranged so that a first group of adjacent entries consist of two-mode entries and a second group of adjacent entries consist of three-mode entries.

12. The method of claim 11, further comprising:
sorting the first group according to costs associated with respective two-mode entries;
sorting the second group according to costs associated with respective three-mode entries, wherein the second group is sorted independently from the first group.

13. The method of claim 11, further comprising parsing an indicator from the video bitstream, wherein the indicator indicates whether the entry is from the first group or the second group.

14. The method of claim 11, further comprising determining whether to select the entry from the first group or the second group based on coded information.

15. The method of claim 1, further comprising determining whether at least a predetermined number of neighboring blocks are coded using TIMD, wherein the candidate list is constructed when at least the predetermined number of the neighboring blocks are coded using TIMD.

16. The method of claim 1, further comprising determining a size of the candidate list for the current block.

17. The method of claim 16, wherein the size of the candidate list is determined based on at least one of:
a block size of the current block; and
whether a dual-tree or single-tree coding is used for the current block.

18. The method of claim 16, wherein the size of the candidate list is based on a number of entries corresponding to the set of neighboring blocks that have a cost that is less than a predetermined value.

19. A method of video encoding performed at a computing system having memory and one or more processors, the method comprising:
receiving video data comprising a current picture that includes plurality of blocks, the plurality of blocks including a current block;
for each neighboring block in a set of neighboring blocks of the current block, when the neighboring block is coded using a template-based intra prediction mode derivation (TIMD), populating a candidate list for the current block with an entry for the neighboring block, wherein at least one entry in the candidate list comprises a three-mode entry;
encoding the current block using an entry from the candidate list; and
signaling the encoded current block in a video bitstream.

20. A non-transitory computer-readable storage medium storing a video bitstream that is generated by a video encoding method, the video encoding method comprising:
receiving video data comprising a current picture that includes plurality of blocks, the plurality of blocks including a current block;
for each neighboring block in a set of neighboring blocks of the current block, when the neighboring block is coded using a TIMD, populating a candidate list for the current block with an entry for the neighboring block, wherein at least one entry in the candidate list comprises a three-mode entry; and
encoding the current block using an entry from the candidate list.
